(19) United States
(12) Patent Application Publication
(10) Pub. No.: US 2025/0180469 A1
(43) Pub. Date: Jun. 5, 2025

(54) OPTICAL INTEGRATED CHIP AND HIGH RESOLUTION LOW-COST INTEGRATED HANDHELD MINIATURE SPECTROMETER

(71) Applicant: AP Infosense Limited, Hong Kong (HK)

(72) Inventors: Zunyue ZHANG, Hong Kong (HK); Hon Ki TSANG, Hong Kong (HK)

(21) Appl. No.: 18/844,391

(22) PCT Filed: Jun. 13, 2023
(86) PCT No.: PCT/IB2023/056063

§ 371 Date: Sep. 6, 2024

(30) Foreign Application Priority Data
Oct. 19, 2022 (HK) 32022062347.6

(51) Int. Cl. G01N 21/31; G02B 6/12

(52) U.S. Cl. CPC G01N 21/31; G02B 6/12014; G01N 2201/0221; G02B 2006/12164

(57) ABSTRACT

An optical integrated chip (70A,70B,70C) integrated with a silicon substrate(s) includes a wavelength multiplexer/demultiplexer (72A,72B,72C), a first light guiding element (74), and a plurality of second light guiding elements (76,78). The wavelength multiplexer/demultiplexer (72A,72B,72C) has a first and a second optical coupling regions (C1,C2) opposite to each other. The first light guiding element (74) is optically coupled to the wavelength multiplexer/demultiplexer (72A,72B,72C) through the first optical coupling region (C1) thereof. The plurality of second light guiding elements (76,78) optically coupled to the wavelength multiplexer/demultiplexer (72A,72B,72C) through the second optical coupling region (C2) thereof. In addition, a high resolution low-cost integrated handheld miniature spectrometer system is also provided.

### FIELD OF THE INVENTION

The present invention generally relates to an optical element and an optical system. More specifically the present invention relates to an optical integrated chip (or a photonic integrated circuit) and an optical system adopting the aforesaid optical integrated chip (or a photonic integrated circuit).

### BACKGROUND OF THE INVENTION

Optical coherence tomography (OCT) is a 3D imaging technique usually employed by ophthalmologists, cardiologists and oncologists. The micro-level depth resolution and centimeter depth range of OCT have made it ideal for medical imaging of the retina and coronary arteries. Disease, such as diabetic retinopathy, has become a leading cause of blindness among the adult population, which bring demands for routine eye screening. For retinal diseases, early detection via regular patient screening can be crucial in introducing treatment before potentially permanent vision loss occurs. OCT is an excellent screening tool to use to detect retinal pathology, early disease and to follow treatment success.

Time-domain OCT (TD-OCT) performs a time domain auto-correlation of the reflected light with the reference path light by a mechanical scan of the reference path length. A scanning element such as a microelectromechanical system (MEMS) mirror or galvanometer-based scanner placed in the sample arm allow 2D cross-sections or 3D volumes to be acquired.

Swept-Source OCT (SS-OCT) suffers the disadvantage of needing an expensive high tuning rate laser, which are considerably more expensive than broadband LEDs. Limitation of current OCT systems is high cost, which is reflected in studies of patient-screening rates. Their availability can be limited outside of larger eye clinics, hospitals, and research laboratories.

Classical spectral-domain OCT (SD-OCT) system needs precision mechanical parts, resulting in increasing the cost and also adding a requirement for the environment to be free from mechanical vibrations. Furthermore, the spectrometers in the SD-OCT systems available in the market relies on classical optical designs incorporating bulk optical lenses precisely aligned with diffraction grating. Such a configuration has large dimension/volume, which is disadvantageous to detect. Thus, there is a need to reduce the volume of the SD-OCT system.

### SUMMARY OF THE INVENTION

It is an objective of the present invention to provide an optical integrated chip and an optical system at least to solve the aforementioned technical problems.

In accordance with an aspect of the present invention, an optical integrated chip is provided. The optical integrated chip is integrated with a silicon substrate. The optical integrated chip includes a wavelength multiplexer/demultiplexer, a first light guiding element, and a plurality of second light guiding elements. The wavelength multiplexer/demultiplexer have a first and a second optical coupling regions opposite to each other. The first light guiding element is optically coupled to the wavelength multiplexer/demultiplexer through the first optical coupling region thereof. The plurality of second light guiding elements optically coupled to the wavelength multiplexer/demultiplexer through the second optical coupling region thereof.

In accordance with an aspect of the present invention, a high resolution low-cost integrated handheld miniature spectrometer system to detect an object is provided. The spectrometer system includes a shell, a light source, a splitter, a reference arm, a sample arm, a spectrometer including the aforesaid optical integrated chip, at least one optical sensor, and a processor. The shell includes a main body portion and a handle grip portion extending from the main body portion. The light source is disposed in the main body portion of the shell and configured to emit an optical signal. The splitter is disposed in the main body portion of the shell and coupled to the light source, the splitter configured to split the optical signal into a first and a second portions. The reference arm is disposed in the main body portion of the shell and coupled to the splitter to receive the first portion of the optical signal to generate a reference optical signal. The sample arm is disposed in the main body portion of the shell and coupled to the splitter to receive the second portion of the optical signal and guides the second portion of the optical signal to the object. The second portion of the optical signal is reflected by the objected to generate a sample optical signal to generate a sample optical signal. The spectrometer is disposed in the main body portion of the shell and coupled to the splitter to receive an interference optical signal resulting from a combination of the reference optical signal and the sample optical signal. The optical sensor is disposed in the main body portion of the shell and is configured to receive and convert the interference optical signal processed by the optical integrated chip into an electrical signal. The processor is coupled to the optical sensor and configured to receive the electrical signal, such that the processor generates an image based on the electrical signal.

Based on above, in the embodiments of the present disclosure, elements of the optical integrated chip are integrated with a silicon substrate, such that the elements therein can be fabricated by a semiconductor manufacturing process. The optical integrated chip can achieve a favorable manufacturing accuracy, a compact size, and light weight. Accordingly, the optical system adopting the optical integrated chip can have a small volume and a good performance.

### BRIEF DESCRIPTION OF THE DRAWINGS

Embodiments of the invention are described in more details hereinafter with reference to the drawings, in which:

FIG. 1 depicts a schematic diagram illustrating an optical system according to an embodiment of the present disclosure;

FIG. 2A depicts a block diagram of an optical integrated chip according to an embodiment of the present disclosure;

FIG. 2B depicts a schematic diagram illustrating a top view of an optical integrated chip according to an embodiment of the present disclosure;

FIG. 2C depicts a vertical cross-sectional view of a bending waveguide portion in the FIG. 2B;

FIG. 2D depicts a vertical cross-sectional view of a straight waveguide portion in the FIG. 2B;

FIG. 3A depicts a light intensity spectrum of the combined light beam in the FIG. 1;

FIG. 3B depicts a light intensity spectrum of a filtered light beam outputted by the tunable optical filter before and after modulation;

FIG. 3C depicts a data processing procedure of the system in the FIG. 1A;

FIG. 4A depicts a block diagram of an optical integrated chip according to an embodiment of the present disclosure;

FIG. 4B depicts a schematic diagram illustrating a top view of an optical integrated chip according to an embodiment of the present disclosure;

FIG. 5A depicts a schematic diagram illustrating a top view of an optical integrated chip according to an embodiment of the present disclosure;

FIG. 5B depicts a vertical cross-sectional view of a bending waveguide portion in the FIG. 5A;

FIG. 5C depicts a vertical cross-sectional view of a straight waveguide portion in the FIG. 5A;

FIG. 6A depicts a schematic diagram illustrating a top view of an optical integrated chip 70D according to an embodiment of the present disclosure;

FIG. 6B depicts light intensity spectra of a combined light beam, 1st order diffracted light beam, and a 2nd order diffracted light beam at different positions in the FIG. 6A; and

FIG. 7 depicts a schematic diagram illustrating an optical system according to an embodiment of the present disclosure.

### DETAILED DESCRIPTION

In the following description, devices, systems, compounds, materials, and/or methods and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

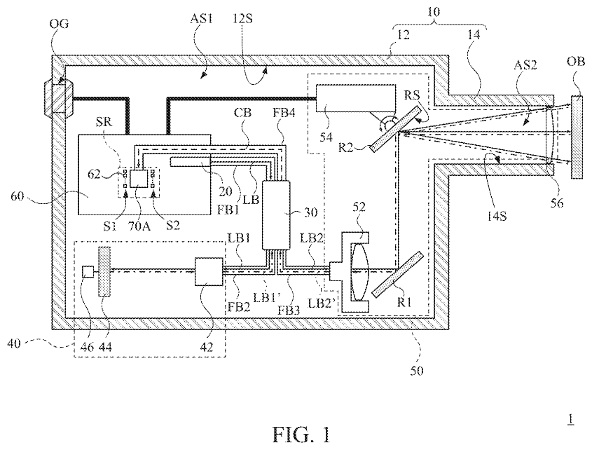

FIG. 1 depicts a schematic diagram illustrating an optical system 1 according to an embodiment of the present disclosure.

Referring to FIG. 1, in the embodiments of the present disclosure, an optical system 1 refers to a various of elements arranged in a specific order, so as to achieve optical information processing. The optical system 1 can be, for example, an optical coherence tomography (OCT) system, or an optical communication network. At least for the convenience of explanation, the OCT system is taken as an example of the optical system 1 for illustrating the present disclosure, and the present disclosure is not limited thereto. The optical system 1 is configured to detect an object OB/sample. In some embodiments, the object OB can be retina of an eye, blood vessel, skin, lungs, or other suitable biological sample, and the present disclosure is not limited thereto. In some embodiments, the optical system 1 can be applied to three-dimensional (3D) imaging processing for different fields, for example, skin & otology, hair, nail health, odontology and other medical images sensing, detecting dental decay, industry inspection, 3D profiling, multilayer inspection, display and panels, drug coating, metrology of precision-machined parts, surface roughness detection, or non-destructive testing. The present disclosure is not limited thereto.

The optical system 1, for example, can be a SD-OCT system. The optical system 1 includes a shell 10, a light source 20, a beam splitter 30, a reference arm 40, a sample arm 50, a circuit board 60, and a spectrometer SR. In the embodiments, the spectrometer SR includes, for example, a plurality of optical sensors 62 and an optical integrated chip 70A.

The shell 10 is designed to house and provide a protect function to all of the aforesaid elements except the shell 10 itself. The shell 10 includes a main body portion 12 and an extending portion 14 extending from the main body portion 12. An inner sidewall 12S of the main body portion 12 defines an accommodating space AS1, and an inner sidewall 14S of the extending portion 14 defines an accommodating space AS2, in which the accommodating space AS1 communicates with the accommodating space AS2. In some embodiments, the shell 10 can be manufactured by a 3D printed technology, such that the optical system 1 can be more light weight and manufactured in a more efficient way. In some embodiments, the exemplary materials of the shell 10 can be plastic, polylactic acid, acrylonitrile butadiene styrene (ABS) or other suitable materials.

The light source 20 is disposed in the accommodating space AS1 of the main body portion 12. The light source 20 can include at least one element capable of emitting light beam. In the embodiments of the present disclosure, the light source 20 can be a broadband light source/low coherence light source. Examples of the light source 20 can include light emitting diode (LED), super luminescent diode (SLD), or halogen lamp. Specifically, the light source 20 is selected to be a non-temperature-controlled SLD with a low manufacturing cost. The light source 20 can emit a light beam LB (i.e., optical signal), in which the light beam LB is a broad band light beam. In some embodiments, a full width at half maximum (FWHM) of the light beam LB can be in a range of 1280 nm to 1340 nm (1310±30 nm), in which peak wavelength of the light beam LB can be, for example, 1310 nm. In other embodiments, a full width at half maximum (FWHM) of the light beam LB can be in a range of 820 nm to 880 nm (850±30 nm). An appropriate wavelength range of the light beam can be selected according to the detection requirements. The peak wavelength of a light beam LB is defined as a wavelength corresponding to the maximum light intensity in the light intensity spectrum thereof. The present disclosure is not limited thereto.

The beam splitter 30 is disposed in the accommodating space AS1 of the main body portion 12. The beam splitter 30 is disposed on a transmission path of the light beam LB from the light source 20. That is to say, the beam splitter 30 is disposed on downstream of a light path of the light source 20. The beam splitter 30 can be an optical element that splits an incident light beam in two beams with different light paths. For example, the beam splitter 30 can split the light beam LB into two light beams LB1, LB2 with different light paths. The light source 20, the two light beams LB1, LB2 are optically coupled to each other by the beam splitter 30. In some embodiments, the beam splitter 30 can includes a fiber optic coupler. Specifically, the beam splitter 30 includes a 2×2 fiber optic coupler. In some embodiments, the beam splitter 30 can provide from about a 50/50 to about a 90/10 split ratio, and the present disclosure is not limited thereto.

The reference arm 40 is disposed in the accommodating space ASI of the main body portion 12. The reference arm 40 is disposed on a transmission path of a light beam coming from the beam splitter 30. The reference arm 40 is disposed on a downstream of a light path of the beam splitter 30. The reference arm 40 includes a lens 42, a reflective element 44, and an actuator 46. The lens 42 has a plurality of lens elements arranged along an optical axis, in which each of the lens elements has refracting power. The reflective element 44 can reflect at least a portion of a light beam.

The sample arm 50 is disposed in the accommodating spaces AS1, AS2 of the shell 10. The sample arm 50 includes a collimator 52, a scanning mirror controlling system 54, a plurality of mirrors R1, R2, and an objective lens element 56. The collimator 52, the scanning mirror controlling system 54, and the mirrors R1, R2 are disposed in the accommodating space AS1 of the main body portion 12. The objective lens element 56 is disposed in the accommodating space AS2 of the extending portion 14.

The collimator 52 is an optical element that transforms an incident light beam into a collimating light beam. The collimator 52 is disposed on a transmission path of a light beam coming from the beam splitter 30. The mirror R1 is disposed on a transmission path of a light beam coming from the collimator 52. The mirror R2 is disposed on a transmission path of a light beam coming from the mirror R1, in which the mirror R2 is controlled by the scanning mirror controlling system 54, such that the actuation of a reflective surface RS of the mirror R2 can be controlled during the operation period of the optical system 1. Thus, light exiting direction of a light beam can be determined by the scanning mirror controlling system 54. In some embodiments, the scanning mirror controlling system 54 includes a micro-electro-mechanical system (MEMS) or a galvo mirror scan system. The objective lens element 56 has refracting power.

The circuit board 60 is disposed in the accommodating space AS1 of the main body portion 12. The circuit board 60 can include, for example, a printed circuit board (PCB), a rigid PCB (RPCB), or a flexible printed circuit board (FPCB). The light source 20 and the optical integrated chip 70A are mounted on the circuit board 60. The circuit board 60 is electrically coupled to the scanning mirror controlling system 54, such that a controller (not shown) of the circuit board 60 can control the scanning mirror controlling system 54. The main body portion 12 of the shell 10 further has an opening OG, and the circuit board 60 can be electrically coupled to an external power supplier (not shown) through the opening OG.

The optical sensors 62 refers to an element that senses/detects at least one light beam/optical signal and transform it into at least one electrical signal. In some embodiments, the optical sensor 62 can include a complementary metal oxide semiconductor (CMOS) type optical sensor, a charge-coupled device (CCD) type optical sensor, or other suitable optical sensor. In some embodiments, the optical sensors 62 can be, for example, disposed on the circuit board 60 and located at two sides of the optical integrated chip 70A. A set of the optical sensors 62 are disposed at a left side S1 of the optical integrated chip 70A, and another set of the optical sensors 62 disposed at a right side S2 of the optical integrated chip 70A. The number of each set of the optical sensors 62 is plural, and these optical sensors 62 can be arranged, for example, in a line array, and each set of the optical sensors 62 can collectively act as a line scan sensor. In other embodiments, positions of the optical sensors 62 can be changed to meet different device requirements, and the present disclosure is not limited thereto.

Referring to FIG. 1, the light source 20 emits a light beam LB. The light beam LB passes through the beam splitter 30 through an optical fiber FB1. The beam splitter 30 splits the light beam LB into two light beams LB1, LB2, so as to transmit to the reference arm 40 and the sample arm 50, respectively.

With respect to the reference arm 40, the light beam LB1 passes through the lens 42 and the reflective element 44 in sequence, and then is reflected by the reflective element 44. The aforesaid optical path can be referred as to a reference optical path. Then, the reflected light beam LB1′ is reflected back to the beam splitter 30 along the reference optical path. The reflected light beam LB1′ can be viewed as a reference optical signal.

With respect to the sample arm 50, the light beam LB2 passes through the collimator 52 through the optical fiber FB3 and is collimated by the collimator 52. The light beam LB2 passes through the mirror R1 and is reflected by the mirror R1, the mirror R2 and is reflected by the mirror R2, penetrates the objective lens element 56, and then arrives an object OB near an end of the extending portion 14. The aforesaid optical path can be referred as to a sample optical path. Then, the light beam LB2 is reflected by the object OB, and thus the reflected light beam LB2′ includes information of the object OB. The reflected light beam LB2′ is reflected back to the beam splitter 30 along the aforesaid light path. The reflected light beam LB2′ can be viewed as a sample optical signal.

In some embodiments, the scanning mirror controlling system 54 can control the mirror R2 to rotate according to a rotating axis. In some embodiments, the scanning mirror controlling system 54 can control the mirror R2 to rotate according to at least two rotating axes.

The reflected light beams LB1′, LB2′ are combined into a combined light beam CB. The combined light beam CB is transmitted to the optical integrated chip 70A through the optical fiber FB4. As the optical integrated chip 70A receives the combined light beam CB, the combined light beam CB would be processed by the optical integrated chip 70A, thereby outputting to at least one optical sensor 62 by the optical integrated chip 70A. During the operation period of the optical system 1, the actuator 46 can adjust the position of the reflective element 44, such that an optical path difference between the light beams LB1, LB2 can be adjusted. In the other embodiments, the reference arm 40 can include an adjustable-length lens to adjust the reference optical path to match the sample optical path. The reflected light beams LB1′, LB2′ in the combined light beam CB interferes with each other and form interference patterns. Then, the optical sensors 62 can detect the interference patterns (e.g., interference optical signal) of the combined light beam CB and transform them into electrical signals. The optical integrated chip 70A and the optical sensors 62 can collectively act as a spectrometer SR. The optical sensors 62 are electrically coupled/connected to a processor (not shown) of the optical system 1. The processor of the optical system 1 can analyze the electrical signals to generate image information of the object OB.

In some embodiments, the processor can be external to the shell 10, in which the circuit board 60 is electrically coupled to the processor through the opening OG. In some embodiments, the processor can be located in the shell 10, and the present disclosure is not limited thereto. In the embodiments, the processor can be, for example, a central processing unit (CPU) with one core or multiple cores, a microprocessor, or other programmable processing unit, digital signal processor (DSP), programmable controller, application specific integrated circuits (ASIC), programmable logic device (PLD) or other similar devices, and the present disclosure is not limited thereto. In some embodiments, the processor can be a computer. The detailed configuration and optical effect of the optical integrated chip 70A would be fully described in the following paragraphs

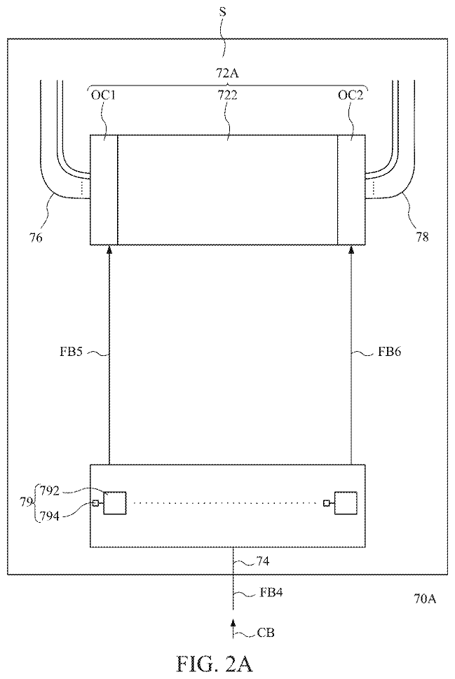

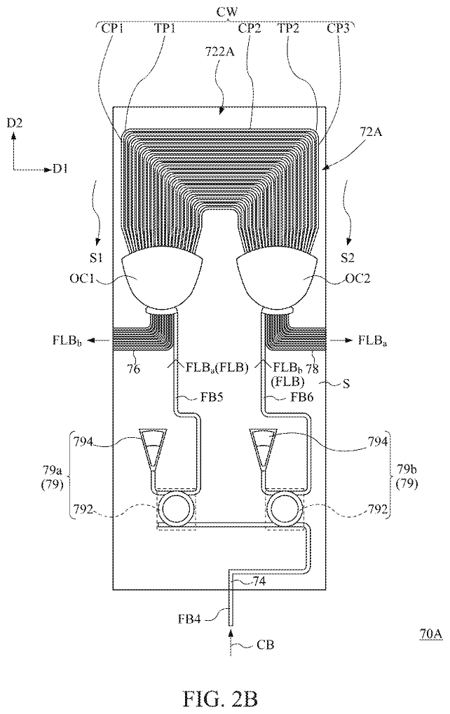

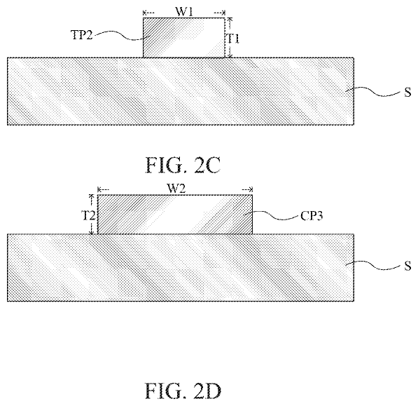

FIG. 2A depicts a block diagram of an optical integrated chip according to an embodiment of the present disclosure. FIG. 2B depicts a schematic diagram illustrating a top view of an optical integrated chip 70A according to an embodiment of the present disclosure. FIG. 2C depicts a vertical cross-sectional view of a bending waveguide portion TP2 in the FIG. 2B. FIG. 2D depicts a vertical cross-sectional view of a straight waveguide portion CP3 in the FIG. 2B.

Referring back to FIG. 1, the optical integrated chip 70A is optically coupled to the reference arm 40 and the sample arm 50 through the beam splitter 30 and the optical fiber FB4. Referring to FIGS. 2A and 2B, the optical integrated chip 70A (or can be referred to as a photonic integrated circuit) includes a wavelength multiplexer/demultiplexer 72A, a light guide element 74, a plurality of light guiding elements 76, a plurality of light guiding elements 78, a plurality of tunable optical filter 79, and optical fibers FB5, FB6. It should be noted that the optical integrated chip 70A is integrated with a substrate S, in which the substrate S can be a silicon substrate, or other suitable substrate. Herein, the phrase “the optical integrated chip 70A is integrated with a substrate S” means that the aforesaid elements of the optical integrated chip 70A can be manufactured with/on the substrate S using the semiconductor manufacturing process; and therefore, the optical integrated chip 70A of the present disclosure can achieve a favorable manufacturing accuracy, a compact size, and light weight.

The multiplexer/demultiplexer 72A is an element can have the functions of the multiplexer and demultiplexer. A multiplexer is an element that accepts many inputs but gives one output. A demultiplexer functions exactly in the reverse way of a multiplexer. The demultiplexer accepts one input and gives many outputs. Specifically, along a direction, the multiplexer/demultiplexer 72A can be operated as a multiplexer. Along a reverse direction, and the multiplexer/demultiplexer 72A can be operated as a demultiplexer. That is to say, the multiplexer/demultiplexer 72A can be operated bidirectional. In the SD-OCT optical system 1, the multiplexer/demultiplexer 72A is operated as a multiplexer, and the present disclosure is not limited thereto.

The multiplexer/demultiplexer 72A includes an arrayed waveguide grating (AWG) 722A and two optical coupling regions OC1, OC2 opposite to each other. The optical coupling region OC1 is adjacent to a left side S1 of the multiplexer/demultiplexer 72A, and the optical coupling region OC2 is adjacent to a right side S2 of the multiplexer/demultiplexer 72A. The AWG 722A is located between and optically connects the optical coupling regions OC1 and OC2.

The AWG 722A includes a phased arrayed of channel waveguides CW, which are designed to have a constant path-length difference between two adjacent channel waveguides CW. Each of the channel waveguides CW includes a plurality of straight waveguide portions CP1, CP2, CP3 and a plurality of bending waveguide portions TP1, TP2.

To be more specific, taking a single channel waveguide CW for example, the straight waveguide portions CP1, CP3 extend along a vertical direction D2, in which the straight waveguide portions CP1, CP3 are adjacent to the left side S1 and the right side S2, respectively. The straight waveguide portion CP2 extends along a horizontal direction D1 and is located between the straight waveguide portions CP1 and CP3. The bending waveguide portion TP1 is located between and connects the straight waveguide portion CP1 to the straight waveguide portion CP2. The two adjacent straight waveguide portions CP1, CP2 are connected by the bending waveguide portion TP1. The bending waveguide portion TP2 is located between and connects the straight waveguide portion CP2 to the straight waveguide portion CP3. The two adjacent straight waveguide portions CP2, CP3 are connected by the bending waveguide portion TP2. In the embodiment, the straight waveguide portions CP1, CP2, CP3 and the bending waveguide portions TP1, TP2 can collectively form an inverse U-like shape arrayed waveguide grating in a top view of the optical integrated chip 70A.

In the embodiment, the sizes of the straight waveguide portions CP1, CP2, CP3 are substantially the same, and the sizes of the bending waveguide portions TP1, TP2 are substantially the same. Referring to FIGS. 2C and 2D, a width W1 of the bending waveguide portion TP1/TP2 is different from that of the straight waveguide portions CP1/CP2/CP3. The width W1 of the straight waveguide portion CP1/CP2/CP3 is greater than that of the bending waveguide portions TP1, TP2. A thickness T1 of the bending waveguide portion TP1/TP2 is the substantially the same as that of the straight waveguide portion CP1/CP2/CP3. The aforesaid configuration can avoid optical loss. It should be noted that the cladding layer covering the channel waveguide CW is omitted in FIGS. 2C and 2D.

In some embodiments, the thickness Tl of each of the bending waveguide portions TP1, TP2 and the thickness T2 of each of the straight waveguide portions CP1, CP2, CP3 can be, for example, 220 nm. The width W2 of each of the straight waveguide portions CP1, CP2, CP3 can be, for example, 1 μm. The width W1 of each of the bending waveguide portions TP1, TP2 can be, for example, 450 nm, and the bending radius of the bending waveguide portions TP1, TP2 can be, for example, 10 μm. The present disclosure is not limited thereto.

The material of the channel waveguides CW can be, for example, silicon nitride (SiN).

Each of the optical coupling regions OC1, OC2 includes a slab waveguide, and thus the optical coupling region OC1/OC2 can be referred to as a slab waveguide region. The optical coupling region OC1 is adjacent to the left side S1, and the optical coupling region OC2 is adjacent to the right side S2. The optical coupling region OC1 is located between the straight waveguide portions CP1 and the light guiding elements 76, and the AWG 722A is optically coupled to the light guiding elements 76 through the optical coupling region OC1. The optical coupling region OC2 is located between the straight waveguide portions CP3 and the light guiding elements 78, and the AWG 722A is optically coupled to the light guiding elements 78 through the optical coupling region OC2. The layout of the optical coupling regions OC1, OC2, the channel waveguides CW, and light guide elements 76 and 78 follows a Rowland circle configuration, such that when a point light source is placed on a point of the Rowland circle, the spectrum of the light source is focused on another point of this circle.

The light guiding elements 74, 76, 78 refer to an optical element that at least one light beam can transmit/propagate therein and be guided thereby. In the embodiments, each of the light guiding elements 74, 76, 78 can include an optical fiber. The light guide element 74 is disposed between the optical fiber FB4 and the tunable optical filters 79, and the tunable optical filters 79 are optically coupled to the optical fiber FB4 through the light guide element 74. The light guiding elements 76 are optically coupled to the optical coupling region OC1, and extend from the optical coupling region OC1 to a region at a left side S1, thereby optically coupling to a set of the optical sensors 62 in the FIG.1. The light guiding elements 78 are optically coupled to the optical coupling region OC2, and extend from the optical coupling region OC2 to a region at a right side S2, thereby optically coupling to another set of the optical sensors 62 in the FIG. 1.

The tunable optical filters 79 refer to an optical element that can filter light beams with a specific wavelength range according to characteristics of the environment where it located. In the embodiment, the number of the tunable optical filters 79 is, for example, two. The two tunable optical filters are labeled as 79a and 79b in the FIG. 2B. The tunable optical filters 79 are disposed at an upstream of an optical path of the multiplexer/demultiplexer 72A. Each of the tunable optical filter 79 includes an optical filter 792 and a modulation device 794. Each of the optical filters 792 includes a micro ring resonator (MRR), in which the micro ring resonator includes a closed loop waveguide. The optical filters 792 of the tunable optical filter 79a, 79b are optically coupled to the optical fiber FB4 through the light guiding element 74. The optical filter 792 of the tunable optical filter 79a/79b can be optically coupled to the optical fiber FB5/FB6. The optical filter 792 of the tunable optical filter 79b is optically coupled to the optical coupling region OC2 through the optical fiber FB6.

The modulation device 794 is coupled to the optical filter 792, and is configured to adjust the characteristic of the optical filter 792. In the embodiments, the modulation device 794 includes a temperature modulation device, and the modulation device 794 is configured to adjust temperature of the optical filter 792. The modulation device 794 can include, for example, a heater. The environment where the tunable optical filters 79 is located can be changed by providing voltage/current to the heater of the modulation devices 794.

The mechanism of the optical integrated chip 70A will be fully described as follows.

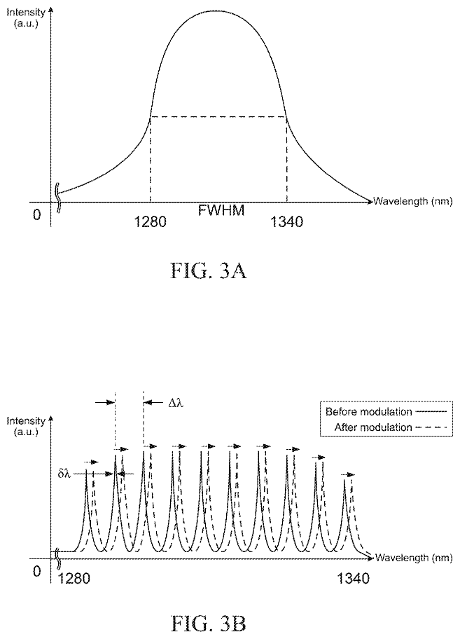

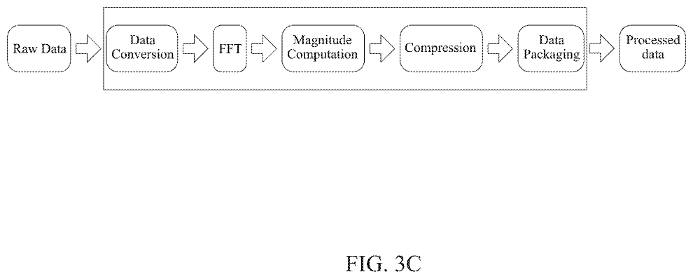

FIG. 3A depicts a light intensity spectrum of the combined light beam CB in the FIG. 1. FIG. 3B depicts a light intensity spectrum of a filtered light beam outputted by the tunable optical filter before and after modulation.

Referring to FIG. 3A, a full width at half maximum (FWHM) of the combined light beam CB falls in a range of 1280 nm to 1340 nm (1310±30 nm), in which the combined light beam CB is a broadband light beam. Referring back to FIG. 2B again, different portions of the combined light beam CB are transmitted to the different tunable optical filters 79a, 79b through the light guide element 74, respectively. Each of the tunable optical filters 79a, 79b receives the corresponding portion of the combined light beam CB from the light guide element 74. As at least one sub-light beam of the combined light beam CB with a specific peak wavelength meets resonant conditions of the MRR, the aforesaid sub-light beam would gradually enhance its the light intensity in the MRR due to constructive interference. Then, the aforesaid sub-light beam can output the MRR through the optical fiber FB5/FB6. On the contrary, the other sub-light beams of the combined light beam CB would be filtered by the optical filter 792 because of failing to meet the resonant conditions of the MRR.

Based on above, each of the tunable optical filters 79a, 79b can filter the corresponding portion of the combined light beam CB, and output a filtered light beam FLB with at least one sub-light beams complying with the resonant conditions of the MRR, in which each of the sub-light beams is a narrow band light beam. The light intensity spectrum of the filtered light beam FLB is shown by a thick black line in the FIG. 3B before the optical filter 792 is modulated by the modulation device 794.

Then, the filtered light beams FLBₐ coming from the tunable optical filter 79a enters the optical coupling region OC1 through the optical fiber FB5 and then diffracts into a plurality of sub-light beams in the optical coupling region OC1, such that sub-light beams of the filtered light beams FLBₐ enter the channel waveguides CW of the AWG 722A, respectively. That is to say, the sub-light beams of the filtered light beams FLBₐ are separated by the AWG 722A. In this case, the AWG 722A act as a light dispersive element. Then, the sub-light beams of the filtered light beams FLBₐ pass through the optical coupling region OC2 and enter the light guiding elements 78 respectively, and output to a region at the right side S2 of the multiplexer/demultiplexer 72A from the light guiding elements 78. A set of the optical sensors 62 at right side S2 can detect the sub-light beams of the filtered light beams FLBa.

Similarly, the filtered light beams FLB_{b} coming from the tunable optical filter 79b enters the optical coupling region OC2 through the optical fiber FB6 and then diffracts in the optical coupling region OC2, such that sub-light beams of the filtered light beams FLB_{b} enter the channel waveguides CW of the AWG 722A, respectively. That is to say, the sub-light beams of the filtered light beams FLB_{b} are separated by the AWG 722A. Then, the sub-light beams of the filtered light beams FLB_{b} pass through the optical coupling region OC1 and enter the light guiding elements 76, respectively, and output to a region at the left side S1 of the multiplexer/demultiplexer 72A from the light guiding elements 76. Another set of the optical sensors 62 at left side S1 can detect the sub-light beams of the filtered light beams FLB_{b}.

In the embodiment, a plurality of the tunable optical filters 79a, 79b are directly optically with the optical coupling regions OC1, OC2 through the optical fibers FB5, FB6, respectively, in which the optical fibers FB5, FB6 act as light input fibers for the filtered light beams FLBₐ, FLB_{b}. Each of the optical coupling regions OC1, OC2 is further optically coupled with a plurality of light guiding elements 76/78, in which different sets of light guiding elements 76/78 act as light output fibers for the sub-light beams of filtered light beams FLBa, FLB_{b}, respectively. During the operation of the optical integrated chip 70A, the sub-light beams of filtered light beams FLBₐ, FLB_{b} can propagate in the same AWG 722A along two opposite directions, respectively. Two different sets of optical sensors 62 are disposed at left and right sides S1, S2 of the multiplexer/demultiplexer 72A, and then the sub-light beams of the filtered light beams FLBₐ/FLB_{b} can be detected/received by the optical sensors 62 at two different sides S1, S2. Thus, the optical sensors 62 can transform the sub-light beams of the filtered light beams FLBₐ/FLB_{b} into a first set of electrical signals in a first time period.

Thereafter, the modulation device 794 modulates/adjusts the characteristic of the optical filter 792. Specifically, the temperature modulation device 794 modulates (e.g., enhances) the temperature of the optical filter 792. That is to say, in the embodiment, the temperature modulation device 794 and the optical filter 792 can collaboratively act as a heater-tuned micro ring resonator. Since the temperature of the optical filter 792 is changed, the characteristic (e.g., radius) of the MRR would change correspondingly. The resonant wavelengths complying with the resonant conditions of the MRR would be changed, and thus peak wavelengths of sub-light beams of the filtered light beam FLB are shifted. The light intensity spectrum of the filtered light beam FLB is shown by a dotted black line in the FIG. 3B after the optical filter 792 is modulated by the modulation device 794. Thus, the optical sensors 62 can transform the sub-light beams of the filtered light beams FLBₐ/FLB_{b} into a second set of electrical signals in a second time period; and so on.

In some embodiments, a magnitude of a wavelength shift of the tunable optical filter 79a can be different from that of the tunable optical filter 79b. In some embodiments, a magnitude of a wavelength shift of the tunable optical filter 79a can be the same as that of the tunable optical filter 79b. By such adjustments, different optical detection requirements can be realized.

Generally speaking, in order to achieve high-resolution spectral detection, the more channel waveguides and optical sensors are required, resulting in an obvious inter-channel crosstalk issue and a high manufacturing cost.

However, in the embodiments of the present disclosure, the upstream of an optical path of the wavelength multiplexer/demultiplexer 72A is provided with the tunable optical filters 79a, 79b. The tunable optical filters 79a, 79b can filter the input light beam (e.g., the combined light beam CB) to form filter light beams FLBₐ, FLB_{b} with a plurality of sub-light beams/narrowband light beams, respectively. To be more specific, by operation of the modulation devices 794, peak wavelengths of the sub-light beams can be shifted at least one or more times. The optical filter 792 (e.g., MRR) and the modulation device 794 can operate collaboratively to shift peak wavelengths of the sub-light beams of the filtered light beam, so that the different sets of electrical signals corresponding to different wavelengths can be detected by the optical sensors 62 in different time periods.

In some embodiments, the number of the channel waveguides CW can be, for example, 20. The effective channel number of the tunable optical filter 79 is determined by a product of the number of the channel waveguides CW and the wavelength shifting times of the sub-light beams. The wavelength shifting times are limited by the spectral linewidth of the MRR. It usually uses a formula Δλ/δλ to determine the maximum times of the shift, in which Δλ is the wavelength tuning range and ϵλ is the 3-dB linewidth of the transmission spectral line of the MRR. In some embodiments, the shift times of the sub-light beams can be, for example, 40 times. Thus, the effective channel number of the tunable optical filter 79 is 800 (20*40), which is much greater than the number of actual channel waveguides CW.

The resolution of the optical integrated chip 70A is determined by a formula A/B, in which A represents a FWHM of input light signals of the optical integrated chip 70A and B represents the effective channel number of the tunable optical filter 79. In this case, the FWHM of input light signals of the optical integrated chip 70A is, for example, 60 nm. The resolution of the optical integrated chip 70A is 0.075 nm (60 nm/800). In other words, by the cooperation of the modulation device 794 and the optical filter 792, the number of effective channel number can be greatly increased instead of fabricating actual channel waveguides, thereby reducing the manufacturing complexity, avoiding possible inter-channel crosstalk issue and achieving a high-resolution spectral detection using fewer number of the channel waveguides CW. That is to say, the optical integrated chip 70A can achieve a better optical performance at low cost.

Furthermore, in the embodiment of the present disclosure, the optical integrated chip 70A is integrated with a silicon substrate S by a semiconductor manufacturing process, and therefore, the optical integrated chip 70A can maintain a compact chip footprint. The optical integrated chip 70A with small volume can replace bulk optical designs and a diffraction grating used in the traditional SD-OCT system. The volume of the optical system 1 adopting the optical integrated chip 70A can be greatly reduced, and portability of the optical system 1 is greatly improved.

In addition, each of the optical coupling regions OC1, OC2 of the multiplexer/demultiplexer 72A is disposed with a plurality of light guiding elements 76/78, respectively, in which a set of the light guiding elements 76 and a set of the light guiding elements 78 extend to different sides S1, S2 of the multiplexer/demultiplexer 72A, respectively. Therefore, the optical sensors 62 can be arranged on different sides S1, S2 instead of being arranged densely. Such a configuration can alleviate the manufacturing complexity of the spectrometer SR.

It should be noted that the optical sensors 62 are disposed on the circuit board 60 and located at an external of the optical integrated chip 70A in the above embodiment. In other embodiments, the optical sensors 62 can be integrated/fabricated with the optical integrated chip 70A by a semiconductor manufacturing process, such that the optical sensors can be optically coupled to the light guiding elements 76, 78 in the substrate S, thereby avoiding possible aligning errors and insertion optical loss. In these embodiments, the optical integrated chip itself can serve as a chip-based spectrometer, and the optical integrated chip integrated with the optical sensors occupies a chip area about 2 cm². The optical integrated chip integrated with the optical sensors can maintain a compact chip footprint. In some embodiments, the optical sensors 62 and the optical integrated chip 70A can be co-packaged.

In other embodiments, the tunable optical filter can modulate the characteristics of the optical filter through the magneto-optical effect. For example, the modulation device of the tunable optical filter can include a magnetic field modulation device to modulate the magnetic field near the optical filter, such that the refractive index of the optical filter (MRR) can be changed through the magneto-optical effect, and thus the resonant conditions of the MRR would be changed. Accordingly, peak wavelengths of sub-light beams of the filtered light beams can be shifted by aforesaid configuration.

FIG. 3C depicts a data processing procedure of the system in the FIG. 1A. Referring to FIG. 3C, in some embodiments, the optical sensors 62 are electrically coupled to a chip in the processor, not limited to a commercial DSP chip on the market or a custom-made ASIC DSP chip. The output of such the DSP chip will be coupled to the input pins for further processing. The raw data (i.e., the electrical signals transformed by the optical sensors) passed to the processor is comprised of data/electrical signals from different optical sensors 62.

The data processing procedure is simplified and enhanced because of the beneficial design of the optical integrated chip 70A. As the filtered light beams FLBa/FLBb with different peak wavelengths are evenly spaced inside the AWG 722A of the optical integrated chip 70A (See FIG. 2B), the output data is therefore evenly spaced in k-domain. Such a benefit reduces the complexity of the processing algorithms. After the raw data is transferred to the processor, the raw data is converted from 8bit to 32bit floating-point complex datatype.

After that, the raw data is processed by a fast fourier transform (FFT) process, a magnitude computation process, data compression process, and data packaging process in sequence, so as to obtain processed data. The processed data is reduced to in an appropriate dynamic range, and will be passed for visualization. The processed data will then be passed to other systems for further processing, visualization or storage.

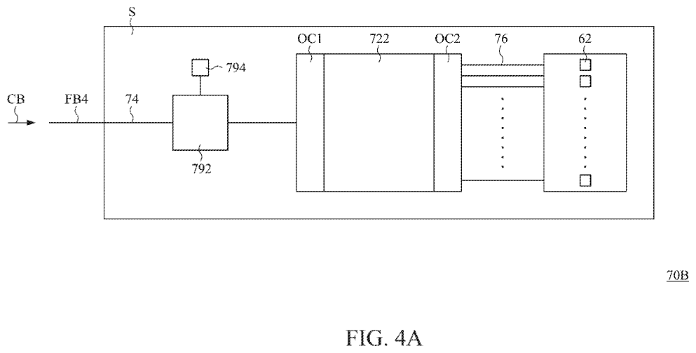

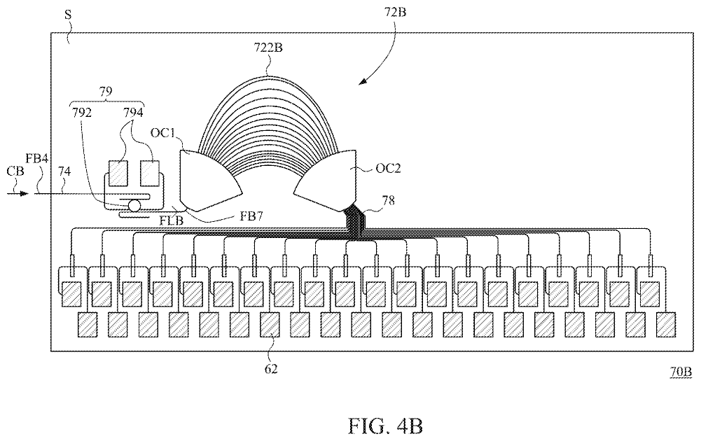

FIG. 4A depicts a block diagram of an optical integrated chip 70B according to an embodiment of the present disclosure. FIG. 4B depicts a schematic diagram illustrating a top view of an optical integrated chip 70B according to an embodiment of the present disclosure. The optical integrated chip 70B is similar to the optical integrated chip 70A as described and illustrated with reference to FIGS. 2A and 2B, except that the number of the tunable optical filter 79 is one. The optical coupling region OC1 is optically coupled to the optical filter 792 through the optical fiber FB7. The AWG 722B of the wavelength multiplexer/demultiplexer 72B has a plurality of curved channel waveguides CW. The light guiding elements 78 extend from the optical coupling region OC2 to a region at an underside of the AWG 722B. The optical sensors 62 are arranged at an underside region of the AWG 722B, and optically coupled to the optical coupling region OC2 through the light guiding elements 78.

In the embodiment, the sub-light beams of the filtered light beam FLB coming from the tunable optical filter 79 can propagate along a direction in the AWG 722B. Then, the sub-light beams of the filtered light beams FLB can be detected/received by the optical sensors 62 at the underside region of the AWG 722B. Such a configuration can meet a specific device requirement.

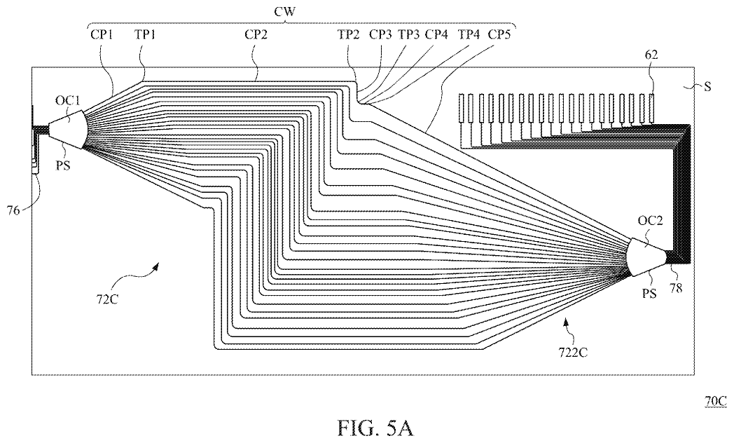

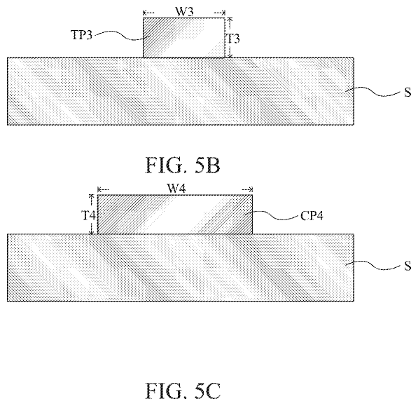

FIG. 5A depicts a schematic diagram illustrating a top view of an optical integrated chip 70C according to an embodiment of the present disclosure. FIG. 5B depicts a vertical cross-sectional view of a bending waveguide portion TP3 in the FIG. 5A. FIG. 5C depicts a vertical cross-sectional view of a straight waveguide portion CP4 in the FIG. 5A. The optical integrated chip 70C is similar to the optical integrated chip 70A as described and illustrated with reference to FIGS. 2A and 2B, except that the AWG 722C of the wavelength multiplexer/demultiplexer 72C includes a plurality of straight waveguide portions CP1˜CP5 and a plurality of bending waveguide portions TP1˜TP4. The straight waveguide portions CP1˜CP5 and the bending waveguide portions TP1˜TP4 can collectively form a Z-like shape AWG 722C. The two ends of the Z-like shaped AWG 722C are connected to the optical coupling regions OC1, OC2, in which the optical coupling region OC1 is located at an upper left region of the AWG 722C and the optical coupling region OC2 is located at a lower-right region of the AWG 722C. The optical sensors 62 can be arranged at an upper-right region of the AWG 722C, and the light guide elements 78 can extend from the optical coupling region OC2 to the optical sensors 62. Thus, a more compact optical integrated chip 70C can be achieved.

In the embodiment, the sizes of the straight waveguide portions CP1˜CP5 are substantially the same, and the sizes of the bending waveguide portions TP1˜TP4 are substantially the same. Referring to FIGS. 5B and 5C, the width of the straight waveguide portion CP1˜CP5 is greater than that of the bending waveguide portions TP1˜TP4. A thickness of the bending waveguide portion TP1/TP2/TP3/TP4 is the substantially the same as that of the straight waveguide portion CP1/CP2/CP3/CP4/CP5. The aforesaid configuration can avoid optical loss. It should be noted that the cladding layer covering the channel waveguide CW is omitted in FIGS. 5B and 5C.

In some embodiments, the thickness T3 of each of the bending waveguide portions TP1˜TP4 and the thickness T4 of the straight waveguide portions CP1˜CP5 can be, for example, 220 nm. The width W3 of each of the bending waveguide portions TP1˜TP4 can be, for example, 450 nm, and the bending radius of the bending waveguide portions TP1˜TP4 can be, for example, 20 μm. The width W4 of each of the straight waveguide portions CP1˜CP5 can be, for example, 800 nm, and such a design can suppress the phase errors. The present disclosure is not limited thereto.

In the embodiment, the optical integrated chip 70C does not include the aforesaid tunable optical filter to achieve a more compact design. In some embodiments, the optical integrated chip 70C can include the aforesaid tunable optical filter located an upstream of optical path of the AWG 722C.

In some embodiments, the shape of each of the optical coupling region OC1, OC2 can be designed to a parabolic-taper shape PS, such a design can reduce coupling loss between the channel waveguides CW and the optical coupling region OC1, and reduce coupling loss between the channel waveguides CW and the optical coupling region OC2. In some embodiments, by such a configuration, transmission of 99.5% can be obtained.

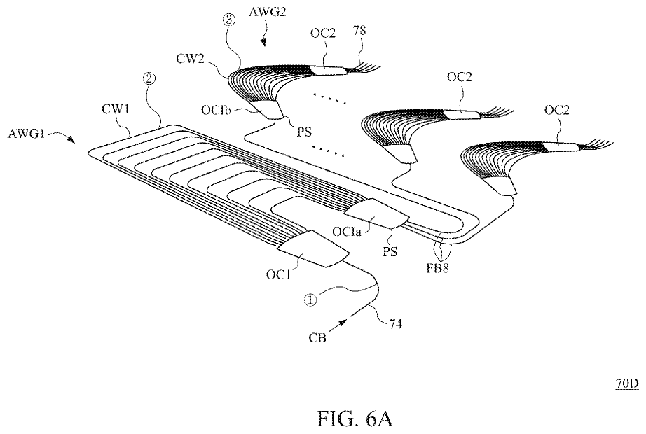

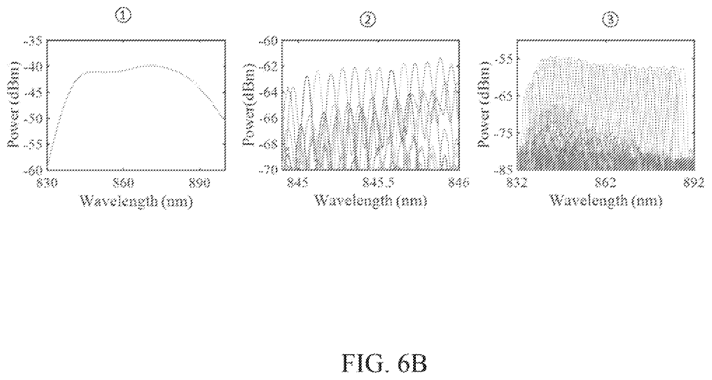

FIG. 6A depicts a schematic diagram illustrating a top view of an optical integrated chip 70D according to an embodiment of the present disclosure. FIG. 6B depicts a light intensity spectrum of a combined light beam, 1^{st} order diffracted light beam, and a 2^{nd} order diffracted light beam at different positions 1, 2, and 3 in the FIG. 6A.

Referring to the FIG. 6A, with respect to the optical integrated chip 70C, the wavelength multiplexer/demultiplexer includes a primary-stage arrayed waveguide grating AWG1 and a plurality of secondary-stage arrayed waveguide gratings AWG2. The primary-stage arrayed waveguide grating AWG1 has an optical coupling region OC1 and an intermediate optical coupling region OCIa. Each of the secondary-stage arrayed waveguide gratings AWG2 has an intermediate optical coupling region OCIb and an optical coupling region OC2. The intermediate optical coupling regions OCIa, OCIb are located between the optical coupling regions OC1, OC2. The intermediate optical coupling region OCIa of the primary-stage arrayed waveguide grating AWG1 is optically coupled to the intermediate optical coupling region OCIb of each of the secondary-stage arrayed waveguide gratings AWG2 through the corresponding optical fiber FB8. By such a configuration, the primary-stage arrayed waveguide grating AWG1 and theses secondary-stage arrayed waveguide gratings AWG2 collectively form a tandem/cascaded AWG arrangement.

In the embodiment, the number of the channel waveguides CW1 of the primary-stage AWG1 is designed to be less than the number of the channel waveguides CW2 of each of the secondary-stage arrayed waveguide gratings AWG2. For example, the number of the channel waveguides CW1 is 14, and the number of each of the channel waveguides CW2 is 50.

Referring to FIGS. 6A and 6B, the combined light beam CB enters the optical coupling region OC1 of the primary-stage arrayed waveguide grating AWG1 through the light guiding element 74 and diffracts in the optical coupling region OC1 to form 1^{st} order diffracted light beam, and then the 1^{st} order diffracted light beams of the combined light beam CB can enter the channel waveguides CW1, respectively. That is to say, the combined light beam CB would roughly diffract in the optical coupling region OC1 of the primary-stage arrayed waveguide grating AWG1 to form 1^{st}-order diffracted light beams with a greater FWHM (See FIG. 6B).

Then, theses 1^{st} order diffracted light beams transmit to the intermediate optical coupling regions OCIb of the secondary-stage arrayed waveguide gratings AWG2 through the optical fibers FB8, respectively. Each of the 1^{st} order diffracted light beams diffracts again in the intermediate optical coupling region OCIb to form a plurality of 2^{nd} order diffracted light beams, and these 2^{nd} order diffracted light beams enter the channel waveguides CW2 of the secondary-stage arrayed waveguide gratings AWG2, respectively. That is to say, each of the 1st-order diffracted light beams would finely diffract again in the corresponding secondary-stage arrayed waveguide gratings AWG2 to form 2nd-order diffracted light beams with a smaller FWHM (See FIG. 6B). Then, these 2nd-order diffracted light beams pass through the optical coupling region OC2 and enter the light guiding elements 78, respectively, and then they are detected/received by the optical sensors (not shown).

In some embodiments, the shape of each of the optical coupling region OCIa, OCIb can be designed to a parabolic-taper shape PS, such a design can reduce coupling loss between the channel waveguides CW1 and the optical coupling region OCIa, and reduce coupling loss between the channel waveguides CW2 and the optical coupling region OCIb.

To reduce the phase errors caused by sidewall roughness of the channel waveguides, a multimode waveguide design is applied to the straight waveguide portion in the channel waveguides CW1/CW2, and a single waveguide design is applied to bending waveguide portion in the channel waveguides CW1/CW2 to suppress excitation of higher order modes.

With respect to the optical integrated chip 70D, the optimum approach is to increase the channel number of the secondary-stage arrayed waveguide grating AWG2 and reduced the channel number of the primary-stage arrayed waveguide grating AWG1, such that the channel number of the secondary-stage arrayed waveguide grating AWG2 can be greater than that of the primary-stage arrayed waveguide grating AWG1. Therefore, the length of the primary-stage arrayed waveguide grating AWG1 can be reduced, thereby avoiding phase error issues. In some embodiments, 10 channel number of the primary-stage arrayed waveguide grating AWG1 and 50 channel number of the secondary-stage arrayed waveguide grating AWG is an optimum design. Thus, the optical integrated chip 70A can have with aforesaid design will have a relatively good performancee and relatively compact footprint. The cascaded AWG spectrometer can provide both high spectral resolution and wide optical bandwidth.

In the embodiment, the optical integrated chip 70D does not include the aforesaid tunable optical filter to achieve a more compact design. In some embodiments, the optical integrated chip 70D can include the aforesaid tunable optical filter located an upstream of optical path of the primary-stage arrayed waveguide grating AWG1.

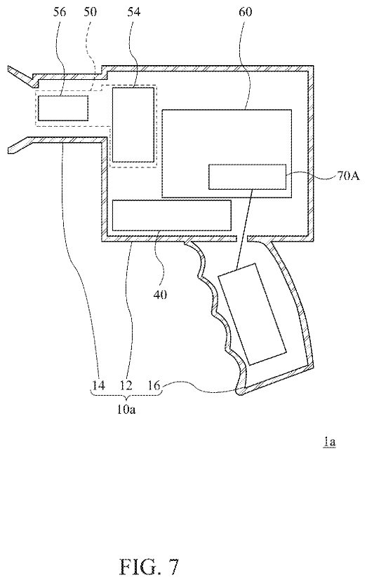

FIG. 7 depicts a schematic diagram illustrating a system 1a according to an embodiment of the present disclosure. The system 1a is similar to the system 1 as described and illustrated with reference to FIG. 1, except that the layout of the internal elements in the shell 10a of the FIG. 7 is different from that of the system 1. In addition, the shell 10a of the system 1a further includes a handle grip portion 16 extending from a bottom of the main body portion 10. The handle grip portion 16 is designed to be held by users, and thus the system 1a can be easily moved and stored, thereby improving the portability of the system 1a.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An optical integrated chip integrated with a silicon substrate, comprising:
a wavelength multiplexer/demultiplexer having a first optical coupling region and at least one second optical coupling region opposite to each other;
a first light guiding element optically coupled to the wavelength multiplexer/demultiplexer through the first optical coupling region thereof, and
a plurality of second light guiding elements optically coupled to the wavelength multiplexer/demultiplexer through the second optical coupling region thereof.

2. The optical integrated chip of claim 1, further comprising at least one tunable optical filter, wherein the tunable optical filter further comprises:
an optical filter optically coupled to the first optical coupling region of the wavelength multiplexer/demultiplexer, wherein the optical filter is configured to receive a broadband light beam from the first light guiding element and filter the broadband light beam, thereby outputting a filtered light beam; and
a modulation device coupled to the optical filter and configured to adjust a characteristic of the optical filter, thereby adjusting optical characteristics of sub-light beams of the filtered light beam.

3. The optical integrated chip of claim 2, wherein the modulation device modulates the characteristic of the optical filter, such that peak wavelengths of sub-light beams of the filtered light beam are shifted.

4. The optical integrated chip of claim 2, wherein the modulation device comprises a temperature modulation device, wherein the temperature modulation device is configured to adjust temperature of the optical filter.

5. The optical integrated chip of claim 2, wherein the at least one tunable optical filter further comprises a first and a second tunable optical filters,
wherein the first and second tunable optical filters receive the broadband light beam through the first light guiding element;
the first tunable optical filter filters the broadband light beam and outputs a first filtered light beam to the wavelength multiplexer/demultiplexer through the first optical coupling region thereof; and
the second tunable optical filter filters the broadband light beam and output a second filtered light beam to the wavelength multiplexer/demultiplexer through the second optical coupling region thereof.

6. The optical integrated chip of claim 5, wherein the first optical coupling region is optically coupled to a plurality third light guiding elements,
the second light guiding elements extend to a first side of the wavelength multiplexer/demultiplexer,
the third light guiding elements extend to a second side of the wavelength multiplexer/demultiplexer opposite to the first side,
wherein,
the first filtered light beam is transmitted to the first side through the wavelength multiplexer/demultiplexer and the second light guiding elements, and
the second filtered light beam is transmitted to the second side through the wavelength multiplexer/demultiplexer and the third light guiding elements.

7. The optical integrated chip of claim 1, wherein the wavelength multiplexer/demultiplexer comprises an arrayed waveguide grating comprising a plurality of channel waveguides, each of the channel waveguides comprises a plurality of straight waveguide portions and a plurality of bending waveguide portions, wherein two adjacent the straight waveguide portions is connected by one of the bending waveguide portions, and a width of the straight waveguide portion is different from that of the bending waveguide portion.

8. The optical integrated chip of claim 7, wherein from a top view of the optical integrated chip, the straight waveguide portions and the bending waveguide portions collectively form a Z-like shaped arrayed waveguide grating.

9. The optical integrated chip of claim 1, wherein the wavelength multiplexer/demultiplexer further comprises a primary-stage arrayed waveguide grating having the first optical coupling region and a plurality of secondary-stage arrayed waveguide gratings having the second optical coupling regions,
wherein the primary arrayed waveguide grating is optically coupled to each of the secondary arrayed waveguide gratings.

10. A high resolution low-cost integrated handheld miniature spectrometer system, configured to detect an object, comprising:
a shell comprising a main body portion and a handle grip portion extending from the main body portion;
a light source disposed in the main body portion of the shell and configured to emit an optical signal;
a splitter disposed in the main body portion of the shell and coupled to the light source, the splitter configured to split the optical signal into a first and a second portions;
a reference arm disposed in the main body portion of the shell and coupled to the splitter to receive the first portion of the optical signal to generate a reference optical signal;
a sample arm disposed in the main body portion of the shell and coupled to the splitter to receive the second portion of the optical signal and guides the second portion of the optical signal to the object, wherein the second portion of the optical signal is reflected by the objected to generate a sample optical signal;
a spectrometer disposed in the main body portion of the shell and coupled to the splitter to receive an interference optical signal resulting from a combination of the reference optical signal and the sample optical signal, wherein the spectrometer comprises an optical integrated chip integrated with a silicon substrate, and the optical integrated chip comprises:
a wavelength multiplexer/demultiplexer having a first optical coupling region and at least one second optical coupling region opposite to each other;
a first light guiding element optically coupled to the wavelength multiplexer/demultiplexer through the first optical coupling region thereof; and
a plurality of second light guiding elements optically coupled to the wavelength multiplexer/demultiplexer through the second optical coupling region thereof;
at least one optical sensor disposed in the main body portion of the shell and configured to receive and convert the interference optical signal processed by the optical integrated chip into an electrical signal; and
a processor coupled to the optical sensor and configured to receive the electrical signal, such that the processor generates an image based on the electrical signal.
